(19) United States
(12) Patent Application Publication
(10) Pub. No.: US 2026/0035276 A1
(43) Pub. Date: Feb. 5, 2026

(54) SYSTEMS AND METHODS FOR ADSORBING PERFLUORINATED COMPOUNDS IN WASTEWATER FROM SEMICONDUCTOR FABRICATION PROCESSES

(71) Applicant: Taiwan Semiconductor Manufacturing Company, LTD., Hsinchu (TW)

(72) Inventors: Hsien-Li He, Hsinchu (TW); Mei Lee, Hsinchu (TW); Shi-Bin Wen, Hsinchu (TW); Tsung-Kai Hsueh, Taichung (TW); Heng-Yi Tseng, Zhubei (TW)

(21) Appl. No.: 18/792,806

(22) Filed: Aug. 2, 2024

(51) Int. Cl. C02F 9/00; B01J 20/20; B01J 39/05; C02F 1/00; C02F 1/28; C02F 1/42; C02F 101/36; C02F 101/38; C02F 103/34

(52) U.S. Cl. CPC C02F 9/00; B01J 20/20; B01J 39/05; C02F 1/004; C02F 1/283; C02F 1/42; C02F 2001/425; C02F 2101/36; C02F 2101/38; C02F 2103/346

(57) ABSTRACT

Methods for removing perfluoroalkyl substances (PFAS) from wastewater derived from semiconductor fabrication or display panel fabrication are disclosed. As part of the treatment, the wastewater passes through a strong acid cation (SAC) unit, resulting in a wastewater stream having an acidic pH. The wastewater stream then passes through an activated carbon filter (ACF) unit to remove perfluoroalkyl substances (PFAS). Desirably, the ACF unit uses activated carbon derived from bituminous coal, which is positively charged at acidic pH and can remove the PFAS with high efficiency. No chemicals need to be added, no backwashing steps are needed, and no pollution emissions occur as a result of these methods.

### BACKGROUND

Integrated circuits are formed on a semiconductor wafer. Photolithographic patterning processes use ultraviolet light to transfer a desired mask pattern to a photoresist on a semiconductor wafer. Etching processes may then be used to transfer to the pattern to a layer below the photoresist. This process is repeated multiple times with different patterns to build different layers on the wafer substrate and make a useful device. Water is used in several steps, and generates wastewater which needs to be treated.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a schematic diagram of one embodiment of a water treatment system, in accordance with some embodiments of the present disclosure.

FIG. 2 is a schematic diagram of a Strong Acid Cation (SAC) unit.

FIG. 3 is a schematic diagram of an Activated Carbon Filter (ACF) unit.

FIG. 4 is a schematic diagram of another embodiment of a water treatment system, in accordance with some embodiments of the present disclosure. This embodiment includes one SAC unit and a plurality of ACF units arranged in parallel and series with each other.

FIG. 5 is a schematic illustration showing the flow of water through a semiconductor fabrication process, in accordance with some embodiments of the present disclosure.

FIG. 6A, FIG. 6B, and FIG. 6C are diagrams illustrating a semiconductor manufacturing step in a manufacturing tool that may use PFAS and/or TMAH, in accordance with some embodiments.

FIG. 7 is a flow chart illustrating a method for reclaiming wastewater from a semiconductor or display panel manufacturing process, or more generally for removing perfluoroalkyl substances (PFAS) from an initial fluid stream, in accordance with some embodiments.

FIG. 8 is a schematic of a water treatment system for producing ultrapure water for semiconductor fabrication purposes, in accordance with some embodiments.

FIG. 9 is a flow chart illustrating a method for producing ultrapure water for use in semiconductor or display panel fabrication, in accordance with some embodiments.

FIG. 10 is a graph showing the zeta potential versus pH for three different types of activated carbon.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Numerical values in the specification and claims of this application should be understood to include numerical values which are the same when reduced to the same number of significant figures and numerical values which differ from the stated value by less than the experimental error of conventional measurement technique of the type described in the present application to determine the value. All ranges disclosed herein are inclusive of the recited endpoint.

The term “about” can be used to include any numerical value that can vary without changing the basic function of that value. When used with a range, “about” also discloses the range defined by the absolute values of the two endpoints, e.g. “about 2 to about 4” also discloses the range “from 2 to 4.” The term “about” may refer to plus or minus 10% of the indicated number.

The terms “inlet” and “outlet” are relative to a fluid flowing through them with respect to a given structure, e.g. a fluid flows through the inlet into the structure and flows through the outlet out of the structure. The terms “upstream” and “downstream” are also relative to the direction in which a fluid flows through various components, i.e. the fluid flows through an upstream component prior to flowing through the downstream component. It should be noted that when a loop is present, a first component can be described as being both upstream of and downstream of a second component.

The term “fluidly connected” is used in the specification to indicate that two components are connected to each other in such a way that a fluid in one component will eventually reach the second component. This term permits other structures and components to be present between the two fluidly connected components.

The term “directly” is used to indicate that the fluid in the first component subsequently flows into the second component, with no other components between them that affect the makeup of the fluid.

The term “wastewater” as used herein refers to water which has been used in a manufacturing step and thus includes byproducts of those steps. The term “tap water” or “feed water” refers to incoming water which has been treated to drinking standards, and may have a conductivity of about 200 to about 300 microSiemens per centimeter (μS/cm). The term “ultrapure water” or “UPW” refers to water that is very low in contaminants such as particles and ions, and may have a conductivity of less than 1 (μS/cm) or a resistivity from 18.0 to 18.25 Mohm-cm.

Water is used in many aspects of semiconductor fabrication, for example cleaning or rinsing the wafer to remove debris between individual manufacturing steps, surface conditioning, stripping, wet etch, solvent processing, chemical mechanical planarization (CMP). The resulting wastewater may contain several different types of contaminants, including acids like sulfuric acid or hydrofluoric acid; polymers; silicates; hydrogen peroxide, slurry particles, metals like copper or iron; and inorganic ions. Such contaminants need to be removed before the water is reused, rerouted, or disposed of. To provide some context, a single fabrication plant may use 2 million to 5 million gallons (7500 to 19000 cubic meters) of water daily.

The present disclosure relates to systems and methods for removing perfluoroalkyl substances (PFAS) from wastewater (especially wastewater generated during semiconductor or display panel fabrication) or tap water. PFAS are compounds that have many fluorine atoms on an alkyl chain (which may range, for example, from C3 to C12). Some non-limiting examples include perfluorooctane sulfonic acid (PFOS), perfluorooctanoic acid (PFOA), fluoroalkyl sulfonamides, fluorinated polymers, and fluorinated sulfonamide alcohols. PFAS may be used during fabrication processes, for example to reduce surface tension, or to improve photolithographic pattern resolution and reduce pattern collapse. They may be used in lubricants, photoresist, wet etch recipes, etch chamber gases, solvents, developers, rinse solutions, or as materials in equipment such as tanks, valves, pumps, and piping. However, PFAS can also have reproductive and developmental effects. Thus, government regulations restrict the amount of PFAS emissions that can occur.

The systems of the present disclosure include the use of a strong acid cation (SAC) unit or tank, which then passes or feeds the treated fluid directly to an activated carbon filter (ACF) unit or tank. The ACF unit uses activated carbon derived from bituminous coal. This almost completely adsorbs PFAS pollutants, especially short-chain C3-C7 PFAS. No backwashing steps are required, no addition of chemicals is required, and no pollution emissions are created. In addition, tetramethylammonium hydroxide (TMAH), which is commonly used as a developer or solvent in semiconductor or display panel fabrication, is also captured by the systems. The resulting treated water can be used as secondary water in various applications.

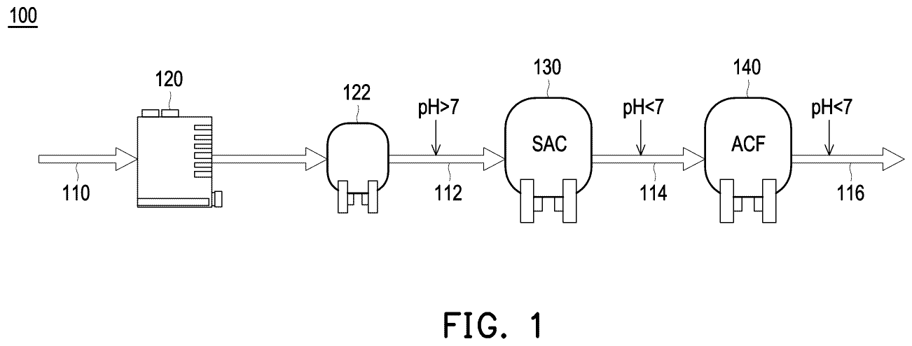

FIG. 1 is a schematic diagram of one embodiment of a water treatment system 100 of the present disclosure for use in treating wastewater resulting from semiconductor or display panel fabrication, in accordance with some embodiments. The system includes a strong acid cation (SAC) unit 130 which is directly upstream of an activated carbon filter (ACF) unit 140. Put another way, the ACF unit is directly downstream of the SAC unit.

Also illustrated is a buffer tank 120 which is downstream of a feed line for a wastewater stream 110. The buffer tank may be used to buffer the system components located further downstream from surges of fluid into the water treatment system. This may occur, for example, as water is used in different manufacturing steps and is then sent to the water treatment system.

The wastewater stream may be produced during semiconductor fabrication, or during display panel fabrication. In particular embodiments, the wastewater stream contains perfluoroalkyl substances (PFAS), which may be used in various manufacturing steps in semiconductor or display panel fabrication. In additional particular embodiments, the wastewater stream also contains tetramethylammonium hydroxide (TMAH), which is commonly used as a developer or solvent. Other contaminants may also be present in the wastewater stream.

A filter 122 is downstream of the buffer tank 120 and upstream of the SAC unit 130. The filter 122 may be, for example, a fibrous matrix formed from polymeric fibers. The polymer may be, in particular embodiments, polypropylene, polyethersulfone, cellulose acetate, nylon, polyester, polyamide, polyethylene, polytetrafluoroethylene, polysulfone, or polyimide. Homopolymers and copolymers of these polymers may also be used, if desired. In particular embodiments, the fibers in the fibrous matrix may have an average diameter of about 0.1 micrometers (μm) to about 10 μm. This may be measured using conventional methods. However, other ranges and values are contemplated and are within the scope of the present disclosure. The filter may possess both high permeability and high ion absorption, making it effective for controlling the concentration of various ions in the wastewater stream. The filter may also be effective for capturing suspended solids that might be present in the wastewater stream.

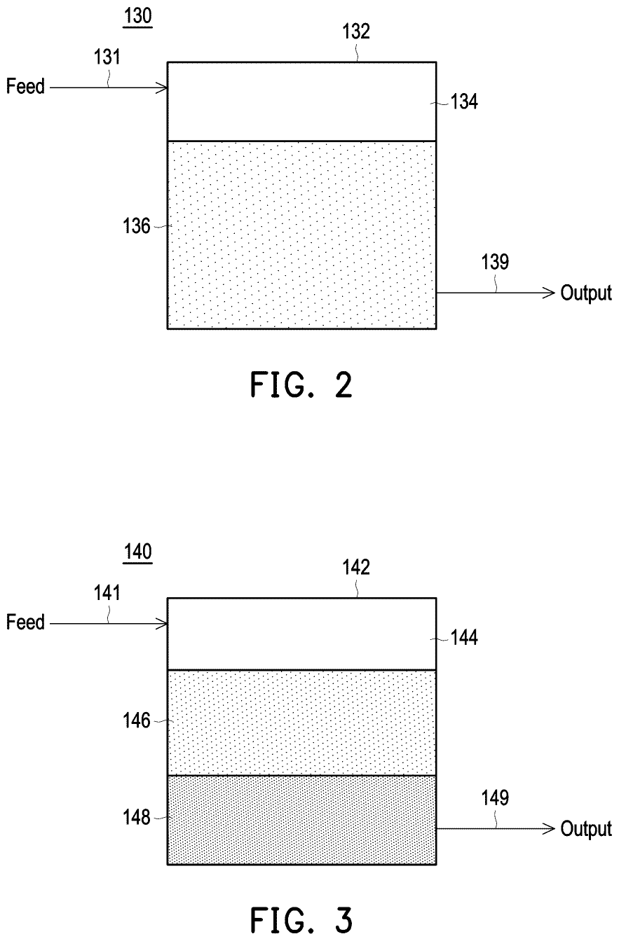

As indicated in FIG. 1, the pH of the wastewater stream 112 entering the SAC unit 130 is usually alkaline, or in other words has a pH of 7 to 14. Referring to FIG. 2, which is a schematic illustration of the SAC unit 130, a housing or tank 132 receives a feed stream 131 illustrated here as entering at the top of the tank. The tank 132 includes an ion exchange layer 136, where various cations in the wastewater stream are captured. Such cations may include the tetramethylammonium ion of TMAH, other quaternary ammonium ions, as well as other metal cations such as calcium, magnesium, iron, or sodium which might be present. These cations are exchanged with hydrogen ions. The ion exchange layer may be, for example, an ion exchange resin provided in the form of beads which are packaged in a bed or in columns. Such ion exchange resins may be made, for example, from crosslinked polystyrene containing sulfonic acid groups. A headspace 134 may be present within the tank over the ion exchange layer. After the feed stream passes through the ion exchange layer under pressure, an output stream 139 exits at the bottom of the tank.

As indicated in FIG. 1, the pH of the wastewater stream 114 exiting the SAC unit 130 and entering the ACF unit 140 is no longer alkaline, but acidic, or in other words has a pH ranging from 7 down to 1. In more particular embodiments, the acidic wastewater stream entering the ACF unit 140 has a pH of 5 or lower, i.e. 5 down to 1. The TMAH concentration of the wastewater stream 114 is also significantly reduced, for example by more than 90%, including more than 95%, including more than 99%, or more than 99.9%, or more than 99.99%, compared to the TMAH concentration in the initial wastewater stream. Other ranges and values are also contemplated and are within the scope of the present disclosure.

Referring now to FIG. 3, which is a schematic illustration of the ACF unit 140, again, a housing or tank 142 receives a feed stream 141 illustrated here as entering at the top of the tank. As illustrated here, the tank contains two bed stages 146, 148 which contain activated carbon particles that are compacted together. However, any number of bed stages may be present, including one stage or more than two stages, as desired. The wastewater flows through one or more of the bed stages. The activated carbon particles adsorb the PFAS present in the wastewater and remove them from the wastewater stream. In particular, short-chain PFAS (C3-C7) are adsorbed at high rates. A headspace 144 may be present within the tank over the bed stages. After the feed stream passes through the activated carbon under pressure, an output stream 149 exits at the bottom of the tank. The concentration of PFAS in the exiting output stream may be heavily reduced compared to the incoming feed stream. In some embodiments, the PFAS concentration in the output stream of the ACF unit is reduced by more than 95%, including more than 99%, including more than 99.9%, or more than 99.99%, or more than 99.999%, compared to the PFAS concentration in the feed stream. In addition, as indicated here, the pH of the exiting output stream is still acidic.

The activated carbon particles used in the ACF unit are derived from coal. In more specific embodiments, the activated carbon particles are derived from bituminous coal. Such activated carbon particles contain micropores having a diameter of less than 2 nanometers. Significantly, activated carbon derived from coal is positively charged at acidic pH, whereas activated carbon derived from coconut shell is negatively charged at acidic pH. The activated carbon may be provided in the form of powder activated carbon, or granular activated carbon, or pelletized activated carbon, as desired.

As indicated in FIG. 1, the pH of the wastewater stream 116 exiting the ACF unit 140 remains acidic. The PFAS concentration of this wastewater stream 116 is reduced by more than 95%, including more than 99%, including more than 99.9%, or more than 99.99%, or more than 99.999%, compared to the PFAS concentration of the initial wastewater stream 110. In some particular embodiments, the PFAS concentration in this exiting wastewater stream 116 may be 10 parts per trillion (ppt) or less. The TMAH concentration of this wastewater stream 116 is also reduced by more than 90%, including more than 99%, compared to the TMAH concentration of the initial wastewater stream 110. The exiting wastewater stream 116 may then be reused, recycled, or discharged. For example, the exiting wastewater stream may be useful for secondary water, such as that used in a cooling tower or a local scrubber.

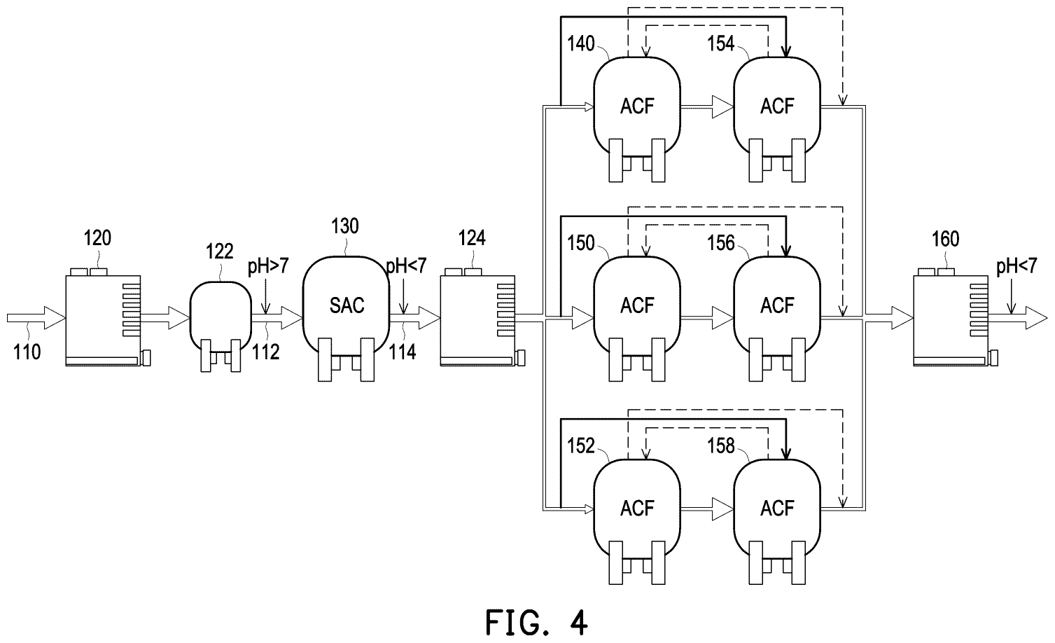

Referring now to FIG. 4, in some particular embodiments, the wastewater stream passes through the SAC unit 130 at a linear flow rate of about 10 meters/hour (m/hr) to about 20 m/hr, including from about 12 m/hr to about 16 m/hr. Similarly, the wastewater stream passes through the ACF unit 140 at a linear flow rate of about 3 m/hr to about 8 m/hr, including from about 4 m/hr to about 6 m/hr. In other particular embodiments, the ratio of the linear flow rate through the SAC unit to the linear flow rate through the ACF unit may be from about 2:1 to about 4:1, including about 3:1. Other ranges and values are also contemplated and are within the scope of the present disclosure. Because the linear flow rate through the ACF unit is lower, it is contemplated that in the system, a plurality of (or multiple) ACF units may be present and arranged in parallel with each other. An example of such a system is illustrated in FIG. 4. Here, the acidic wastewater stream 114 exiting one SAC unit 130 is divided into multiple parallel streams, and each stream flows through at least one ACF unit. Three different streams are illustrated here, with each stream passing through one or two ACF units 140/154, 150/156, 152/158 in series with each other. The wastewater streams exiting the ACF units can then be recombined. Here, a second buffer tank 124 is present after the SAC unit and upstream of the ACF units, and a recycle tank 160 is illustrated where the PFAS-free wastewater streams from the ACF units can be combined together for recycle and/or further downstream processing. The use of a plurality of ACF units also permits individual SAC units to be serviced without requiring shutdown of the entire treatment process. Each ACF unit may include, for example, a tensiometer which measures surface tension and can help determine whether the ACF unit is saturated.

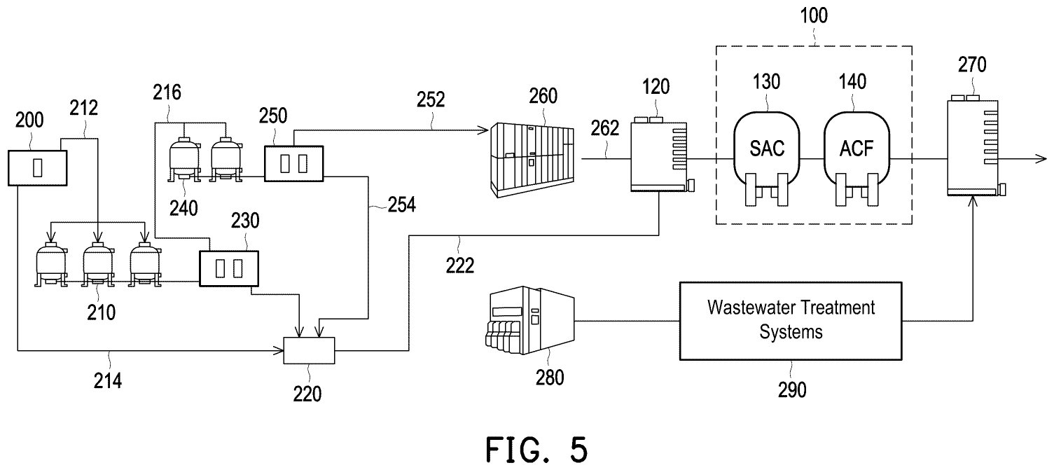

FIG. 5 is a schematic illustration illustrating some portions of the movement of water through a semiconductor fabrication process. A chemical transfer unit (CTU) 200 is used to transfer one or more chemicals to one or more mixing tanks 210 along fluid path 212. A waste fluid path 214 is also illustrated running from the CTU 200 to a sump pit 220, where waste fluids can be collected and combined. Non-limiting examples of chemicals that may be transferred and mixed can include deionized water (DIW), ultrapure water (UPW), surfactants, ammonia, or other additives. Fluids can be transferred from the mixing tanks 210 to a chemical mixing system (CMU) 230, where the fluids are mixed again to improve consistency and reduce variations that may have arisen in the mixing tanks 210. The CMU 230 passes its fluid output along fluid path 216 to a day tank 240, where the fluid is stored for eventual use. A chemical dispense system (CDU) 250 controls the flow of fluid from the day tank 240 along fluid path 252 to the desired manufacturing tool 260. A waste fluid path 254 may run from the CDU 250 to the sump pit 220. Other chemicals, such as TMAH, may also be supplied directly to the desired manufacturing tool 260.

The manufacturing tool 260 creates a wastewater stream 262 that feeds a buffer tank 120. The sump pit 220 may also transfer wastewater fluid 222 to the buffer tank 120.

The buffer tank acts as the feed source for the treatment system 100 that includes an SAC unit 130 and an ACF unit 140 as previously described. The treated effluent exiting the ACF unit, containing significantly reduced levels/concentrations of PFAS and/or TMAH, may be collected in an effluent tank 270 for further downstream processing. Also illustrated are separate tools 280 which feed a separate wastewater treatment system 290, which then feeds the effluent tank 270. This may occur, for example, for tools that do not produce waste streams containing PFAS.

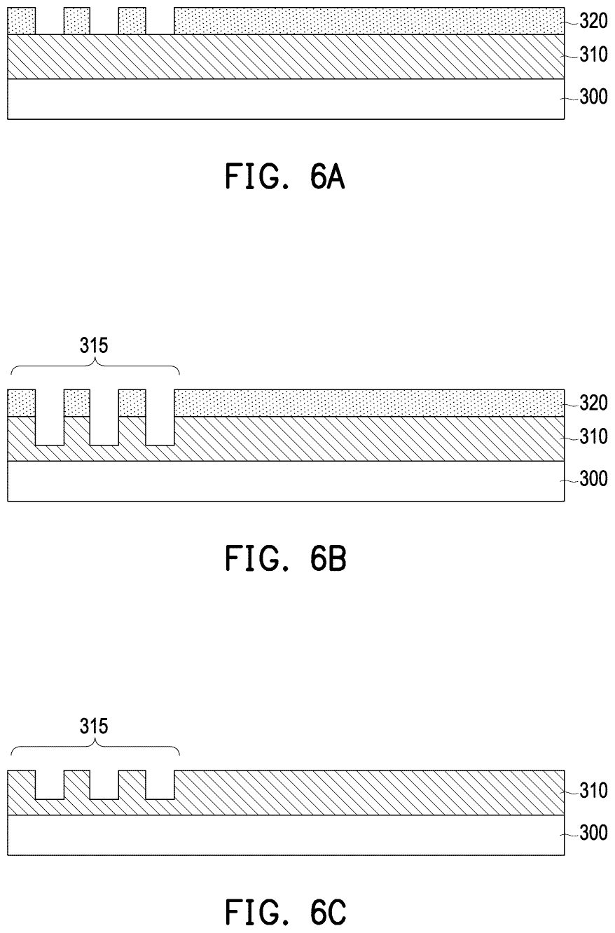

FIGS. 6A-6C are side cross-sectional views illustrating how one tool or process in the semiconductor or display panel manufacturing process may use TMAH and/or PFAS. In FIG. 6A, a metal layer 310 is present on a substrate 300. A photoresist layer 320 upon the metal layer has been applied, patterned, and developed.

For semiconducting devices, the substrate 300 may be, for example, a wafer made of a semiconducting material. Such semiconductor materials can include silicon, for example in the form of crystalline Si. In alternative embodiments, the substrate can be made of other elementary semiconductors such as germanium, or may include a compound semiconductor such as silicon carbide (SiC), gallium arsenide (GaAs), gallium carbide, gallium phosphide, indium arsenide (InAs), indium phosphide (InP), silicon germanium, silicon germanium carbide, gallium arsenic phosphide, or gallium indium phosphide. For a display panel, the substrate 300 may be glass.

Generally, a photoresist layer may be applied, for example, by spin coating, or by spraying, roller coating, dip coating, or extrusion coating. Typically, in spin coating, the substrate is placed on a rotating platen, which may include a vacuum chuck that holds the substrate in plate. The photoresist composition is then applied to the center of the substrate. The speed of the rotating platen is then increased to spread the photoresist evenly from the center of the substrate to the perimeter of the substrate. The rotating speed of the platen is then fixed, which can control the thickness of the final photoresist layer.

Next, the photoresist composition is baked or cured to remove the solvent and harden the photoresist layer. In some particular embodiments, the baking occurs at a temperature of about 90° C. to about 110° C. The baking can be performed using a hot plate or oven, or similar equipment. As a result, the photoresist layer is formed on the substrate.

The photoresist layer is then patterned via exposure to radiation. The radiation may be any light wavelength which carries a desired mask pattern. In particular embodiments, EUV light having a wavelength of about 13.5 nm is used for patterning, as this permits smaller feature sizes to be obtained. This results in some portions of the photoresist layer being exposed to radiation, and some portions of the photoresist not being exposed to radiation. This exposure causes some portions of the photoresist to become soluble in the developer and other portions of the photoresist to remain insoluble in the developer.

An additional photoresist bake step (post exposure bake, or PEB) may occur after the exposure to radiation. For example, this may help in releasing acid leaving groups (ALGs) or other molecules that are significant in chemical amplification photoresist.

The photoresist layer is then developed using a developer. The developer may be an aqueous solution or an organic solution. The soluble portions of the photoresist layer are dissolved and washed away during the development step, leaving behind a photoresist pattern (i.e. a mask). One example of a common developer is aqueous tetramethylammonium hydroxide (TMAH). FIG. 6A shows the resulting structure.

The metal layer is then etched, for example using a dry etch or a wet etch. Referring now to FIG. 6B, a trench 315 is present in the metal layer. In FIG. 6C, the photoresist layer is then removed, for example using a rinse solution. This can be done, for example, using various solvents such as N-methyl-pyrrolidone (NMP) or alkaline media or other strippers at elevated temperatures, or by dry etching using oxygen plasma.

In these process steps, PFAS may be present in the photoresist, or in the etch recipe. TMAH may be used as the developer for patterning the photoresist, and may also be used in the rinse solution. As a result, referring back to FIG. 5, PFAS and TMAH may be present in any wastewater stream exiting such manufacturing tools 260.

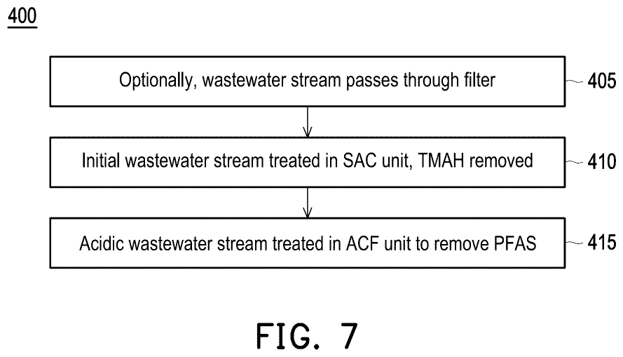

FIG. 7 is a flow chart illustrating a method 400 for reclaiming wastewater from a semiconductor or display panel manufacturing process, or more generally for removing perfluoroalkyl substances (PFAS) from an initial wastewater stream, in accordance with some embodiments. This method is generally illustrated in FIG. 1. While the method steps are discussed below only with reference to certain components in a water treatment system, such discussion should also be broadly construed as permitting the presence of other components as well.

Referring back to FIG. 1, the initial wastewater stream 110 may result, for example, from semiconductor fabrication or display panel fabrication. In optional step 405 of FIG. 7, the initial wastewater stream 110 passes through a filter 122. For example, the filter may be used to trap large particles present in the initial wastewater stream. Next, in step 410 of FIG. 7, the wastewater stream passes through and is treated in a strong acid cation (SAC) unit 130. The resulting output may be referred to as an acidic wastewater stream 114. As previously mentioned, the acidic wastewater stream is reduced in TMAH content, and also has an acidic pH. Then, in step 415 of FIG. 7, the acidic wastewater stream then passes through and is treated in an activated carbon filter (ACF) unit 140 to remove PFAS.

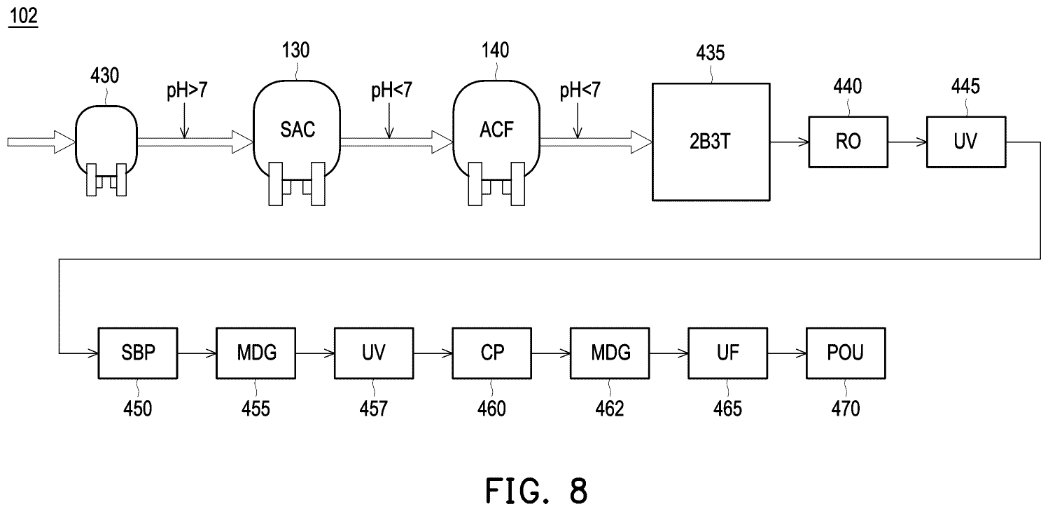

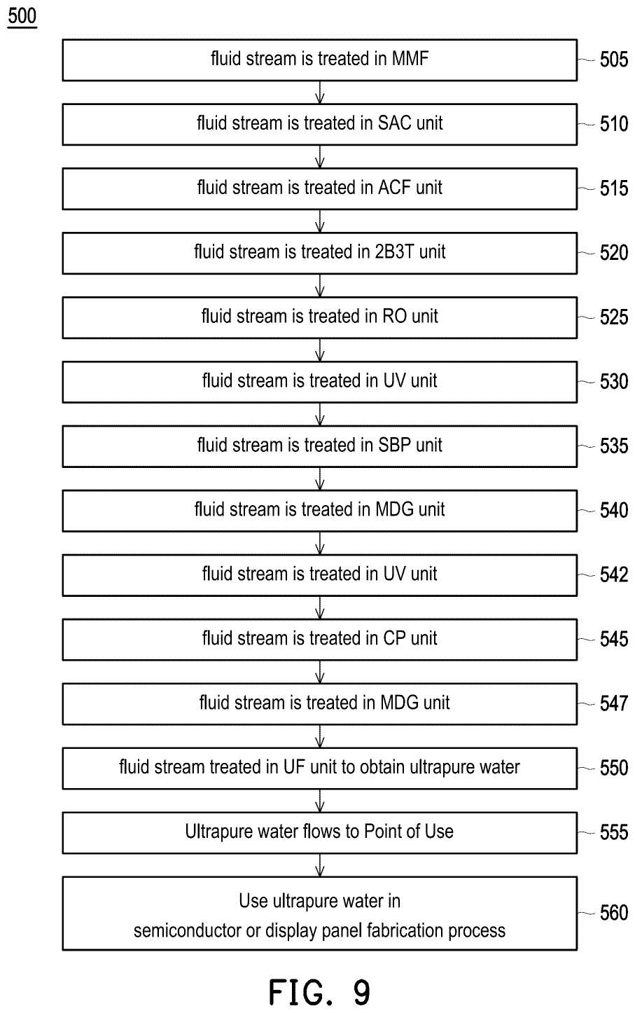

It is also contemplated that the combination of the SAC unit 130 and the ACF unit 140 may be used for removal of PFAS that are in a tap water stream coming into a semiconductor or display panel fabrication facility. FIG. 8 is a schematic illustration of a water treatment system 102 that could be used to produce ultrapure water (UPW) for use in the facility. The system includes the SAC unit and the ACF unit, as well as other units or components for different kinds of treatment of the water to obtain the desired ultrapure water. FIG. 9 is a flow chart illustrating a method 500 for producing ultrapure water, in accordance with some embodiments. These two figures are discussed together.

Very generally, the other units or components of the water treatment system may include one or more of the following: a multi-media filter (MMF) 430, a 2-bed 3-tower (2B3T) unit 435, a reverse osmosis (RO) unit 440, an ultraviolet (UV) unit 445, a stratified bed polisher (SBP) unit 450, a membrane degasification (MDG) unit 455, a second ultraviolet (UV) unit 457, a cautionary polish (CP) unit 460, a second membrane degasification (MDG) unit 462, and an ultrafiltration (UF) unit 465. Not illustrated herein are additional tanks, filters, heat exchangers, pipes, valves, gauges, sensors, etc. which are commonly present as well.

The tap water generally has a total organic content (TOC) content of greater than 0.1 ppm to a maximum of 1.0 ppm. For comparative purposes, the final ultrapure water (UPW) produced at the end of the water treatment system and provided at the point of use desirably has a total TOC content of less than 1.0 part per billion (ppb), and even more desirably less than 0.5 ppb or less than 0.3 ppb. The UPW may also have a resistivity from 18.0 to 18.25 Mohm-cm, and dissolved oxygen content of less than 10 ppb.

Continuing, in step 505 of FIG. 9, the initial fluid stream 110 enters the MMF 430. This is a filter that is typically formed by at least three layers of different media, which are layered by size and density. Larger and less-dense particles are arranged on top, while smaller and denser particles are arranged at the bottom. Common media include anthracite coal (less dense), sand, and garnet (most dense), with a supporting layer of gravel at the bottom. The media form a bed within a tank. Water is fed into the top of the tank, and driven by pressure through the layers to the bottom of the tank, where the treated water is removed. The layering encourages larger contaminants to be trapped near the top, and smaller contaminants to be trapped near the bottom, so the entire depth of the bed can be used for filtering.

The MMF is used to reduce the level of suspended solids (turbidity) in the water stream. Such solids may include, for example, small rocks, soil/silt, organic matter, and plants/microorganisms. An MMF can remove large particles down to particles having an average diameter of about 10 micrometers (μm) to about 25 μm.

Next, in step 510 of FIG. 9, the fluid stream is treated in the SAC unit 130. in step 515 of FIG. 9, the fluid stream is treated in the ACF unit 140. The functions of these two units have already been previously described. As a result, PFAS and other ions, chlorine, organic molecules, and other oxidants present in the water stream are removed.

In step 520 of FIG. 9, the fluid stream leaving the SAC/ACF combination is subsequently treated in a (2B3T) unit 435. This is used to remove other cations and anions, or put another way to demineralize the water stream and improve the water quality. Generally, the unit includes a cation exchanger tower which includes a bed containing a cation-exchange resin that removes cations from the water stream. The output from the cation exchanger tower is used as the feed to a decarbonation tower or degasifier (DC/DG), where carbon dioxide is removed from the water stream. Within the decarbonation tower, the water stream is broken up into small droplets. An air stream blows past the droplets, transferring gas out of the droplets and into the air stream. The decarbonated/degassed droplets are collected at the bottom of the tower. The output from the decarbonation tower is used as the feed to an anion exchanger tower (AEX). The anion exchanger tower includes a bed containing an anion-exchange resin that removes anions from the water stream. The output from the anion exchanger tower continues to a subsequent downstream processing unit.

In step 525 of FIG. 9, the fluid stream is treated in an RO unit 440. The RO unit operates by applying pressure on one side of a partially permeable membrane to push water through the membrane and ideally retain any solute on the pressurized side. The RO unit can remove particles having a size as small as 26 angstroms, depending on the selectivity of the partially permeable membrane.

In step 530 of FIG. 9, the fluid stream is treated in a UV unit 445. Here, the water stream is exposed to UV light, typically at a wavelength of about 254 nm. This destroys viruses and/or bacteria that may be present in the water stream. UV exposure also breaks covalent bonds in organic matter, which aids in further treatment to reduce TOC content.

In step 535 of FIG. 9, the fluid stream is treated in an SBP unit 450. This unit is used to remove metals and ions from the water stream, as well as other remaining suspended solids or organic content. The structure of an SBP unit is similar to that of a MMF, but with multiple layers of resin that act as adsorbents.

In step 540 of FIG. 9, the fluid stream is treated in an MDG unit 455. This unit is used to remove dissolved gases from the water stream. For example, dissolved oxygen can react with and oxidize metals used in the integrated circuits on a semiconductor wafer, creating defects. As another example, dissolved carbon dioxide (and other ions) can increase the electrical conductivity of the water, which can cause short circuits and other defects in the integrated circuits. Such gases are removed by replacement with nitrogen (N₂). In the MDG unit, for example, pure nitrogen gas is brought into contact with the water stream across a hydrophobic membrane. Gas can pass through the membrane, but water cannot. This adjusts gas concentrations across the membrane, decreasing the O₂ concentration in the water stream and increasing the N₂ concentration in the water stream. In step 542 of FIG. 9, the fluid stream is treated in a second UV unit 457.

In step 545 of FIG. 9, the fluid stream is treated in a CP unit 460. A cautionary polish (CP) unit is similar to the SBP unit, and is also used to further remove metals and ions present in the water stream. Upstream processes, such as the UV unit, may create new ions, and the CP unit removes these ions from the water stream. The CP unit may also be considered a second SBP unit, or as a secondary polishing step or a final polishing step. In step 547 of FIG. 9, the fluid stream is treated in a second MDG unit 547.

In step 550 of FIG. 9, the fluid stream is treated in the UF unit 465. This unit is used to filter out particles and molecules of very small size, as small as 2 nanometers (nm). The UF unit is typically the final filtration step to obtain ultrapure water (UPW). It is also contemplated that if desired, any of these treatment steps could be performed again, and/or in a different location in the treatment process. In step 555, the UPW is sent then to a point of use (POU) 470. In step 560, the UPW is used in a semiconductor or display panel fabrication process, for example as discussed above in FIG. 5 and FIGS. 6A-6C.

The systems of the present disclosure have several advantages. PFAS pollutants are almost completely removed from the fluid stream, which complies with regulations. No backwashing steps are needed, and emissions are reduced. No chemicals need to be added to capture PFAS, and the resulting wastewater fluid stream can be recycled or reused. For example, it is contemplated that water discharge may be reduced by up to 95% due to reuse for secondary water applications such as the cooling tower, local scrubbers, etc. As another example, it is contemplated that a given fabrication plant could recycle as much as 400 tons of water per day, with significant cost savings as well while maintaining device yield.

Some embodiments of the present disclosure thus relate to methods for removing perfluoroalkyl substances (PFAS) from an initial wastewater stream coming from a semiconductor or display panel manufacturing process. The initial fluid stream passes through a strong acid cation (SAC) unit to obtain an acidic wastewater stream. The acidic wastewater stream then passes through an activated carbon filter (ACF) unit to remove the PFAS.

Other embodiments disclosed herein relate to water treatment systems for treatment of wastewater from a semiconductor or display panel fabrication process that comprise a strong acid cation (SAC) unit upstream of at least one activated carbon filter (ACF) unit.

Also described in various embodiments herein are methods for reclaiming wastewater from a semiconductor or display panel manufacturing process. The wastewater is sent through a filter. The wastewater then passes through a strong acid cation (SAC) unit to obtain a wastewater stream having an acidic pH. The wastewater stream having an acidic pH then passes through an activated carbon filter (ACF) unit to remove perfluoroalkyl substances (PFAS).

Also disclosed in various embodiments herein are water treatment systems for producing ultrapure water (UPW). Such systems comprise a strong acid cation (SAC) unit upstream of at least one activated carbon filter (ACF) unit. They may also comprise a filter upstream of the SAC unit; a buffer tank upstream of the SAC unit; and/or a plurality of ACF units arranged in parallel so that each ACF unit can receive a fluid stream from the SAC unit. They may also further comprise at least one reverse osmosis (RO) unit; at least one ultraviolet (UV) unit; at least one membrane degasification (MDG) unit; and/or at least one ultrafiltration (UF) unit.

The methods and systems of the present disclosure are further illustrated in the following non-limiting working examples, it being understood that these examples are intended to be illustrative only and that the disclosure is not intended to be limited to the materials, conditions, process parameters and the like recited herein.

### EXAMPLES

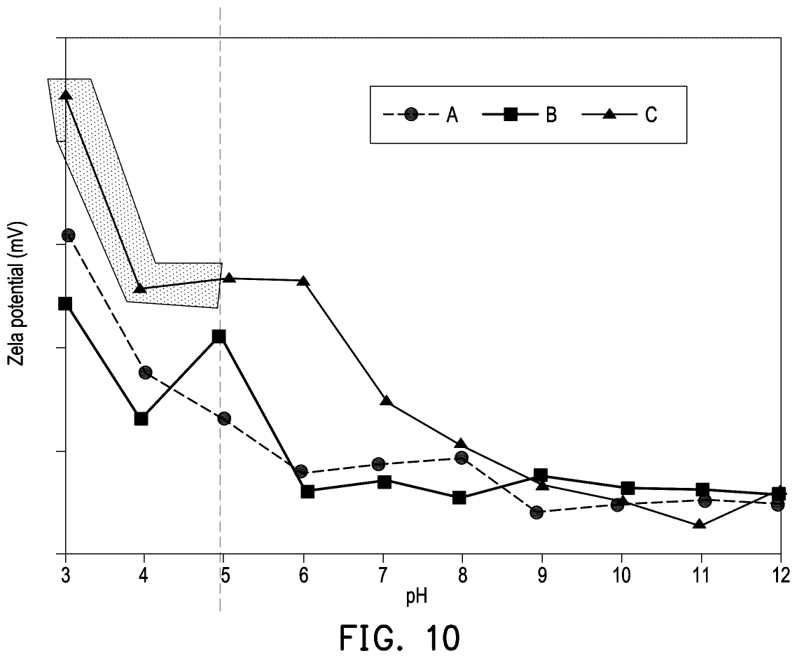

FIG. 10 is a graph showing the zeta potential versus pH for three different types of activated carbon. This is an indication of the adsorption capacity of the activated carbon for PFAS. Type A and Type B were derived from coconut shells. Type C was derived from bituminous coal. As can be seen here, the zeta potential for Type C was significantly greater at all pH from 3 to 7, and especially from pH 3 to 5.

Next, the combination of a SAC unit directly upstream of a ACF unit was implemented in the wastewater system of 11 plants, and the total amount of PFAS in the discharged water was measured. The removal rate of PFAS improved, on average, by 95.5%, with improvements ranging from 93.3% to 99.6%.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method, comprising:
passing the initial wastewater stream through a strong acid cation (SAC) unit to obtain an acidic wastewater stream; and
passing the acidic wastewater stream through at least one activated carbon filter (ACF) unit to remove perfluoroalkyl substances (PFAS).

2. The method of claim 1, wherein the SAC unit captures tetramethyl ammonium hydroxide in the initial wastewater stream.

3. The method of claim 1, wherein the initial wastewater stream passes through the SAC unit at a linear flow rate of less than 15 meters/hour.

4. The method of claim 1, wherein the acidic wastewater stream passes through the at least one ACF unit at a linear flow rate of less than 5 meters/hour.

5. The method of claim 1, wherein the acidic wastewater stream has a pH of 5 or less.

6. The method of claim 1, wherein the at least one ACF unit contains activated carbon derived from bituminous coal.

7. The method of claim 1, wherein the at least one ACF unit contains two compacted bed stages of activated carbon.

8. The method of claim 1, wherein the initial wastewater stream passes through a filter upstream of the SAC unit.

9. The method of claim 1, wherein the acidic wastewater stream is divided into a plurality of streams that each flow through a separate ACF unit, and the plurality of ACF units are arranged in parallel with each other.

10. A water treatment system, comprising:
a manufacturing tool that generates the wastewater; and
a strong acid cation (SAC) unit that receives the wastewater and is located upstream of at least one activated carbon filter (ACF) unit.

11. The system of claim 10, further comprising a filter upstream of the SAC unit.

12. The system of claim 10, further comprising a buffer tank upstream of the SAC unit.

13. The system of claim 10, wherein the system has a plurality of ACF units arranged in parallel so that each ACF unit can receive a fluid stream from the SAC unit.

14. The system of claim 10, wherein the at least one ACF unit contains activated carbon derived from bituminous coal.

15. The system of claim 10, wherein the at least one ACF unit contains two compacted bed stages of activated carbon.

16. A method, comprising:
sending the wastewater through a filter;
passing the wastewater through a strong acid cation (SAC) unit to obtain an acidic wastewater stream having an acidic pH; and
passing the acidic wastewater stream having an acidic pH through at least one activated carbon filter (ACF) unit to remove perfluoroalkyl substances (PFAS).

17. The method of claim 16, further comprising sending the wastewater stream from the ACF unit to a recycle tank.

18. The method of claim 1, wherein the wastewater passes through the SAC unit at a linear flow rate of less than 15 meters/hour.

19. The method of claim 1, wherein the acidic wastewater stream passes through the at least one ACF unit at a linear flow rate of less than 5 meters/hour.

20. The method of claim 1, wherein the at least one ACF unit contains activated carbon derived from bituminous coal.
